(19) United States
(12) Patent Application Publication
(10) Pub. No.: US 2005/0106544 A1
(43) Pub. Date: May 19, 2005

(54) Active agent delivery method

(76) Inventors: Teresa G. Joshi, Irvine, CA (US); Patricia S. Walker, Irvine, CA (US)

Correspondence Address: WALTER A. HACKLER, Ph.D.;LAW OFFICES, 2372 S.E. BRISTOL, SUITE B, NEWPORT BEACH, CA, 92660-0755, US

(21) Appl. No.: 11/016,188

(22) Filed: Dec. 17, 2004

Related U.S. Application Data
(63) Continuation of application No. 10/308,332, filed on Dec. 2, 2002, now abandoned.

(51) Int. Cl. G09B 23/28; G06F 17/60

(52) U.S. Cl. 434/262

(57) ABSTRACT

A method for active agent delivery is provided which includes orchestrating focus groups and clinical studies and the distribution of educational materials and guidelines for counseling patients with regard to what the patients need to know and what the patients must do in order to both avoid adverse side effects while taking doses of active agent and to receive prescriptions for the doses.

The present invention generally relates to delivery of an active agent, or drug, to a patient. More particularly, the present invention is directed to an analysis and method for enabling safe delivery of an active agent, or medicament while avoiding occurrences of known or suspected side effects of the active agent.

A number of active agents or drugs for use in the diagnosis, cure, mitigation, treatment or prevention of conditions of the body for example, acne and psoriasis, are known or suspected of producing adverse side effects. Such side effects include abnormalities, defects, mutations, lesions, or any other injury or degeneration.

Such side effects occur not only in patients taking the active agent, but also in bodies subjected to bodily fluids of the user, such as, for example, a fetus.

Often the active agent is without the side effects in some patients but contraindicated and other individuals.

As an example, certain retinoids, such as isotretinoin, known for inhibiting sebaceous gland function and keratinization, in the treatment of acne and psoriasis, must not be used by females who are pregnant. There is an extremely high risk that a deformed infant will result in pregnancy occurrence while taking isotretinoin (Accutane®) in any amount, even for short periods. Potentially, all exposed fetuses can be affected. Thus, Accutane® is contraindicated in women of child bearing potential, unless the patient meets a number of conditions.

Accordingly, an active agent delivery method is needed for the controlled distribution of an agent, in which all users of the agent are qualified with confirmed assessment of their cognition of active agent risks in order to minimize the possibility that a contraindicated individual will be exposed to the agent.

### SUMMARY OF THE INVENTION

Steps in accordance with one embodiment of the present invention include distributing educational materials to medical office personnel including prescribers who are qualified to prescribe the doses to patients. The educational materials include information as to what the patients need to know and what the patients must do in order to avoid an adverse side effect while taking the doses and to receive a prescription for the doses. This includes providing educational materials as to what adverse side effects may occur and what to do if a specific side effect, in fact, does occur, for example, but not limited to, a change in mood or a vision change.

The method further includes providing guidelines for counseling the patients with regard to what the patients need to know and what the patients must do in order to identify, report and avoid adverse side effects while taking the dose in order to receive prescriptions for the doses. In this manner, adverse effects can be managed.

Further, the method includes orchestrating focus groups for potential patients with regard to what the patients need to know and what the patients must do in order to both avoid the adverse side effect and assessing the perceived knowledge of the potential patient before prescribing the doses for the patients. Such assessment may be done, for example, by surveys or the like.

In addition, the method may optionally include the step of requiring proof of focus group attendance by the patient in order for the patient to receive doses.

More particularly, the method according to the present invention is applicable for active agents in which the adverse side effects includes at least one side effect selected from the group including pregnancy, cheilitis, dry skin, skin fragility, pruritus, epistaxis, dry nose and dry mouth and conjunctivitis. Still, more particularly, the method in accordance with the present invention enables a delivery of Tazarotene.

Further, the method in accordance with the present invention is applicable for active agent having advance event warnings, such as, for example, psychiatric disorders: depression, psychosis and, rarely, suicidal ideation, suicide attempts and suicide; pseudotumor cerebri; pacreatitis; hyperlipidemia; hearing impairment; hepatotoxicity; inflammatory bowel disease; skeletal changes; hyperostosis; premature epiphyseal closure; vision impairment; corneal opacities, decreased night vision.

In addition, the method in accordance with the present invention may include the distribution of educational materials to the prescribers and the method further comprises the step of requiring acknowledgment of receipt of the educational materials and guidelines from the prescribers and further may include the step of requiring acknowledgment from the patients of receipt of the educational materials and completion of surveys.

As noted, the method may further comprise the step of providing survey materials to the prescriber for distribution to the patients regarding identification and awareness of adverse side effects such as what the patient needs to know about the adverse side effects while taking the doses and implementation by the patient of what the patient must do in order to avoid the adverse side effects while taking the doses and to receive prescriptions for the doses. In addition, the method may include the step of receiving completed surveys from the patient. The prescriber may be advised as to continuance or discontinuance of the prescribed doses for the patients.

Further, the method may also include the step of distributing prescribable doses to pharmacies and distributing educational materials to the pharmacies, including pharmacists, with the educational material including information as to what the patient needs to know and what the patients must do in order to identify, report, avoid the adverse side effects while taking the doses and to receive prescription doses from the pharmacists.

In addition, the method may include the step of providing guidelines to the pharmacists for counseling the patient with regard to what the patient needs to know and what the patient must do in order to identify, report, avoid the adverse side effect while taking the dose and to receive doses from the pharmacists. The method may further include the step of requiring acknowledgment of receipt of the educational materials and guidelines from the pharmacists and further acknowledgement of receipt of the educational materials by the patient from the pharmacists.

The method may also include the distribution of educational materials which are age and sex appropriate and include at least materials selected from the group consisting of video tapes, audio tapes, CDs, brochures and line drawings.

The present invention further provides for a method for evaluating effectiveness of educational materials used in a method for delivery of an active agent to a patient. Generally, the method comprises the steps of distributing educational materials to counselors who are qualified to counsel patients, said educational materials including information as to what patients need to know and what the patients must do in order to both avoid adverse side effects while taking the doses and to receive a prescription for the doses and providing guidelines to the counselor for counseling individuals with regard to what the patients need to know and what the patients must do in order to both avoid the adverse side effect while taking the dose and to receive prescriptions for the doses and also what to do if experiencing an adverse effect.

Subsequent to counseling, the method may optionally provide for orchestrating focus groups for the counseled individuals with regard to what the patients need to know and what the patients must do in order to both avoid the adverse side effect, and assessing the perceived knowledge of the counseled individual.

In addition, the present invention provides for a method for conducting a clinical study for enabling delivery of an active agent. The method comprises the steps of preparing prescription doses of an active agent and placebo and providing unidentified prescription doses and placebos to prescribers who are qualified to dispose the unidentified prescription doses and placebos to patients.

Educational materials are distributed to the prescribers, said educational materials including information as to what the patient needs to know and what the patents must do in order to both avoid an undesirable side effect and to receive one of the unidentified prescription doses and placebos or what to do if the patient experiences an adverse side effect.

Guidelines are provided to the prescribers for counseling the patients with regard to what the patients need to know and what the patients must do in order to both avoid the undesirable side effect and to receive one of the unidentified prescription doses and placebo.

Acknowledgment of receipt of the educational material and guidelines is required and survey material are provided for distribution to the patients regarding what the patients need to know about avoiding the undesirable side effect while taking on the unidentified prescribed doses and the placebos and implementation by the patients of what the patient must do in order to both avoid the undesirable side effect and receive one of the unidentified prescription doses and placebos and also, if necessary, manage an adverse side effect.

Completed surveys are received from the patients and the perscribers are advised as to providing one of the unidentified prescription doses and placebos to the patients. Reports from the prescribers as to the effectiveness of administered prescription doses and placebos and the received surveys are statistically analyzed. The survey may qualify a patient for drug administration.

### DETAILED DESCRIPTION

Methods of the present invention provide for Pregnancy Avoidance Contraception on Tazorac® (P.A.C.T.) including treatment and a risk management system. The methods are suitable for use with the delivery of an active agent such as a retinoid. That is, functional and structural derivations of retinoic acid, such as Tazarotene, for the treatment of acne, particularly nodular acne, psoriasis, disorders of Keratinoin and oncology.

Generally speaking, the methods of the present invention may be desirably advantageously used to:
counsel females of childbearing potential about the risk of serious birth defects, miscarriage, death or other risks if the investigational drug, Tazorac® (tazarotene) capsules are taken during pregnancy;
provide an opportunity once the informed consent form has been reviewed and signed for the patient to:
   read and discuss the patient brochure entitled P.A.C.T.™ (Pregnancy Avoidance and Contraception on Tazorac®), “What Women Need to Know”, and,
   view and discuss the video or CD-ROM entitled P.A.C.T.™ (Pregnancy Avoidance and Contraception on Tazorac®) “What Women Need to Know”;
reinforce the required birth control methods and other information to help ensure pregnancy and other risks are avoided while on a clinical study of tazarotene capsules. Review the patient's choices to assure they meet the study criteria and confirm that required birth control has been implemented for at least 28 days prior to study enrollment. Remind patients to advise their doctor if they decide to change birth control methods during the study course; Inform patients as to what to do if birth control fails, i.e. emergency contraception;
reinforce that it is the patient's responsibility to avoid pregnancy by following the study requirements for pregnancy prevention;
conduct pregnancy testing according to the protocol schedule assuring that tazarotene capsules are not dispensed if the patient is found to be pregnant;
remember that the first time in which tazarotene capsules are dispensed is during a woman's menstrual period;
remind abstinent patients that they must advise their doctor of the birth control methods they will use during the study if they were to become sexually active;
instruct patients regarding the availability of emergency contraception and the need to contact their doctor if they were to have sexual intercourse without using the two required birth control methods, or, if they feel their contraceptive method may have failed, i.e., condom broke, diaphragm slipped;
encourage patients to participate in a P.A.C.T.™ Survey.

More specifically, the methods in accordance with the present invention provide for distributing educational materials to medical office personnel including prescribers who are qualified to prescribe the doses for patients. The term, office personnel, further includes paramedics, clerks, nurses and other employees of a physicians office, hospital or medical unit. The term, prescriber, refers to any individual who is able to prescribe drugs as, for example, a medical doctor.

The educational materials preferably include items useful in the counseling of the patient and include, but not limited to, a video tapes, audio tapes, DVDs, CDs, brochures, photographs and other drawings for describing risks and benefits associated with taking the active agents, measures which may be taken to avoid such risks and counseling techniques and advice for the patients including what to do if any adverse side effects occur including stop taking the agent and calling the prescriber.

Education materials preferably include information on contraceptive choices, such as, for example, continuous or periodic abstinence, Outercourse in which sex play is conducted without vaginal intercourse, withdrawal by the male sex partner to prevent the sperm from joining an egg, sterilization, which includes an operation to keep the sperm from joining an egg, hormonal treatment, such as NORPLANT® to prevent a release of an egg and thicken cervical mucus to keep sperm from joining the egg, an intra-uterine device (IUD) an estrogen/progesterone pill, the use of condoms and diaphragm or cervical caps, the use of a female condom or spermicide as well as information on emergency conception, such as, for example, emergency IUD insertion within five days of unprotected intercourse or emergency contraceptive pills. In addition, the education materials may include instruction as to acceptable and non-acceptable medication and addressing contraceptive myths.

In accordance with the methods of the present invention, guidelines are provided for counseling the patients with regard to what the patients need to know and what the patients must do in order to avoid the adverse side effects, including pregnancy, while taking the dose and to receive prescriptions for the doses.

These guidelines include, but are not limited to obtaining a history from the patient by asking key questions to determine if the patient has been sexually active, and for a determination of the level of contraceptive knowledge and experience. Guidelines may be provided for determining patient ability to comply with contraceptive measures.

Such counseling and guidelines should include instruction that the patient may respond to questions avoiding as to what the individuals sexual activity has been or should be and what the patient thinks that the counselor wants to hear in contrast to what is the true facts of the patients sexual activity and pregnancy status.

Guidelines are provided for honing the skills of the counselor, which may be the prescriber, for assessing the patients response and improving communication with the patient.

Nonverbal clues, such as, eye contact, uneasiness, body movements, and general demeanor provide behaviors for which the guidelines are addressed. Guidelines further set forth the establishment of whether the patient fully understands the questions and also providing an environment which is conducive for the patient to be truthful in answering questions.

Such counseling and guidelines may include the isolation of the patient from, for example, parents if the patient is a teenager. In that regard, both the educational materials and guidelines provided under the method of the present invention are preferably age and sex appropriate.

For encouraging both prescriber and patient compliance the method in accordance with the present invention preferably comprises the step requiring acknowledgment of receipt of the educational materials from the prescriber and patient and further acknowledgment of receipt of the guidelines from the prescribers.

In accordance with the present invention focus groups are orchestrated for potential patients with regard to what the patients need to know and what the patients must do in order to both avoid the adverse side effect; and the perceived knowledge of the potential patient is assessed before prescribing the doses for the patients. That is, focus groups are used to evaluate comprehensibility of the materials by the potential patients. Further proof may optionally be required of focus group attendance by the patient in order for the patient to receive doses.

The focus group may be conducted in accordance with the following example:

Research Objectives

The primary objective of the qualitative research was to evaluate the effectiveness of the P.A.C.T. System patient education materials (brochure and video) in communicating to females of childbearing potential (FCBP) the key messages for tazarotene capsules:
tazarotene may cause miscarriage, serious birth defects or death of fetus or baby if taken when pregnant
to avoid these risks, FCBP must not become pregnant while taking tazarotene capsules
two methods of birth control must be used by sexually active FCBP while taking tazarotene capsules. Effective forms of contraception include both primary and secondary forms of contraception. Primary forms of contraception include: tubal ligation, partner's vasectomy, intrauterine devices, birth control pills, and injectable/implantable/insertable hormonal birth control products. Secondary forms of contraception include diaphragms, latex condoms, and cervical caps; each must be used with a spermicide.
   Research Methodology

Six focus groups were conducted in two different cities with 53 FCBP who represent the same age groups as patients who will be enrolled in the acne clinical trials for tazarotene capsules. This age stratification was used to evaluate the clarity and content of the P.A.C.T. System patient education materials among women of different ages and sexual activity. The age groups included were as follows:

| | |
|---|---|
| 12-17 years old: | 2 focus groups |
| 18-29 years old: | 2 focus groups |
| 30-40 years old: | 2 focus groups |

Women were recruited from local consumer databases and screened for eligibility.

| Location | Audiences | # Participants Per Group |
|---|---|---|
| Edison, NJ | 12-17 y.o. FCBP | 9 |
| | 18-29 y.o. FCBP | 8 |
| | 30-49 y.o. FCBP | 8 |
| Irvine, CA | 12-17 y.o. FCBP | 8 |
| | 18-29 y.o. FCBP | 10 |
| | 30-49 y.o. FCBP | 10 |
| | Total | 53 |

Focus groups were 90 minutes in length and were audiotaped and videotaped for referenced and analysis. All sessions were moderated.

Prior to the group discussion, respondents were asked to read the patient brochure and watch the video (the only exception to this flow was that the group of 30-49 y.o. FCBP in Irvine were asked to watch the video first before reading the brochure). After reviewing all materials, all respondents completed a self-administered survey to obtain individual responses before the group discussion began. This allows evaluation of individual responses before the respondents are influenced, either positively or negatively, by the group dynamics.

A discussion guide and worksheet were utilized in the focus groups and attached hereto as Appendix A and Appendix B.

Summary of Findings

The following information summarizes the key findings obtained from 6 focus groups with 53 female consumers representing FCBP in 3 age groups: (1) 12-17 years; (2) 18-29 years; and (3) 30-49 years. Focus groups were conducted in Edison, N.J. and Irvine, Calif.
Across all age groups, the P.A.C.T. System brochure and video were uniformly effective in communicating the key points about tazarotene capsules:
   tazarotene capsules can cause serious birth defects in pregnant women
   women taking tazarotene capsules must not get pregnant while taking the medication.

The P.A.C.T. materials were also very effective in communicating to women in all age groups that two forms of birth control must be used while taking tazarotene capsules in order to avoid getting pregnant, thereby eliminating the risk of serious birth defects.

These messages were clearly communicated and understood by all respondents. In fact, many of the respondents commented that the materials were very repetitious in stating these points “over and over again.” While some of the respondents thought that this was “beating them over the head,” most acknowledge that, in this case, repetition is very effective in making sure they heard and understood the important points. Interestingly, the respondents commented that they did not think it was possible for anyone to read the brochure and watch the video without understanding that “this medicine causes serious birth defects and you must not get pregnant while taking it.”
The only point that was perhaps not as universally clear was the frequency of pregnancy testing. A few respondents did not recall that pregnancy tests are required on a monthly basis. In fact, several respondents suggested that the materials should emphasize that the medication could not be renewed for the next month until after a negative pregnancy test result has been obtained by the doctor.
Teenagers (12-17 y.o.) were able to read and understand P.A.C.T. materials just as well as older women and had the same recall of key points.
Across all age groups, all women agreed that including the pamphlets on contraceptive methods and emergency contraception was “very helpful.” In fact, several women commented that they learned something.
A few respondents in each focus group commented on the use of the word “contraindications” as being a “big, unfamiliar word.” However, several women noted that even though they were not familiar with this term, it was explained/defined clearly so they were able to understand what it means.
Some respondents in each age group indicated they would be somewhat hesitant to participate in a clinical trial with tazarotene, primarily because of the investigational nature of the product and their discomfort with “being in an experiment before the medicine is FDA-approved.” However, most acknowledge that if they had severe acne they might be willing to “try anything.” Across all age groups, the majority of FCBP felt that if they agreed to participate in the clinical trial they would be able to safely take the medication and comply with the requirements. Interestingly, the groups of older women (ages 18-29 years and 30-49 years) commented that they did not think that teenagers would be responsible enough to “follow the rules” and would have difficulty meeting all the requirements for pregnancy avoidance. However, the teenagers themselves did not express any concern. In fact, they indicated the same ability to take the medication safely as did the women in the other groups.
The only point of controversy regarding the P.A.C.T. educational materials was the video. As previously mentioned, 5 of the 6 groups read the brochure first and then watched the videotape. In these groups, there tended to be a somewhat negative reaction to the video primarily because of the amount of repetition and “sameness” of the information presented. A frequent comment was “The video is boring. I didn't learn anything different that what was in the brochure.” A vocal minority of the respondents also complained that the “talk show” or “infomercial” setting of the video was “fake,” “not realistic” and perhaps was not appropriate given the seriousness of the topic. The scripted nature of the dialogue contributed to the feeling that “these are actors, not real people.” Some respondents were also “put off” because the two women in the video did not appear to have any skin problems, therefore they did not come across as “real patients.” However, in looking at the individual ratings of the video recorded on the worksheets prior to the group discussion, the video received neutral to positive ratings from the majority of respondents.

In an attempt to determine if the order in which the brochure and video were reviewed as significant, the last focus group in Irvine watched the video first and then read the brochure. Interestingly, these women were much more positive about the video and did not have the same negative comments about “boring” and “repetitious.” Rather, they suggested that all patients should be required to watch the video in the doctor's office and take the brochure home to read later, when they need to “refresh” their memories about the specific information.
While all women in the focus groups have access to a computer, the vast majority preferred the video format rather than the CD-ROM, commenting that a video is “easier” and “faster” to set up/watch then using the computer. Several also mentioned that the TV screen is larger than the computer screen, making the video easier to watch.
The graphic of the birth defects used in the brochure and video was effective in communicating the seriousness of this issue. However, most of the women in all age groups suggested that graphics might be even more effective if actual pictures rather than drawings could be used. They also suggested including examples of more than just one type of birth defect. While some women felt that the graphic was sufficient “as is,” others thought that additional “real” pictures would “add more shock value and that helps really bring the point home.” Some women commented that the graphics should not be “mixed and matched” and should either use all “real pictures” or use all drawings. Several suggested superimposing the drawing of the enlarged head birth defect over the picture of the normal baby's head to emphasize how much of a difference there is between the normal and defective infants.
Across all age groups, none of the women had any difficulties with answering the questions asked in the P.A.C.T. survey. While they acknowledged that the questions are “personal,” they noted that this is merely a continuation of the same discussions the patient would have with her doctor. Therefore, they did not envision any issues with answering the questions. As one respondent said, “This is part of the deal that you agree to do.”

Younger women were more likely to perceive value in the phone card as an incentive. Women in the 30-49 year old group were less likely to perceive any value with the phone card but indicated they would “give it to somebody else to use.” These women suggested a gift certificate might be more appealing.

Conclusions

The P.A.C.T. System materials are very effective in communicating to FCBP of all ages that: (1) tazarotene causes serious birth defects; (2) women taking tazarotene must not become pregnant; and (3) women taking tazarotene must use 2 forms of birth control and have monthly pregnancy tests in order to avoid taking tazarotene capsules if pregnant.
Despite some negative comments about the video, this program was very effective in communicating the important information about tazarotene capsules. Allergan should consider suggesting to clinical sites that patients watch the video in the office and take the brochure home to read later as a “reminder.”
Younger women (teenagers) appear to have the same comprehension of the requirements for taking tazarotene as older women. Although some women in the 18-29 and 30-49 year age groups expressed concern about the ability of teenagers to be “responsible,” the teenagers themselves did not express this same level of concern. Rather, they indicated that if they made the decision to take tazarotene they believe they could do this responsibly. Interestingly, teenagers were more likely to indicate that they would use abstinence to avoid getting pregnant, a method they viewed as “easier” than a combination of two methods of birth control. Older women with teenage daughters had mixed opinions, with some indicating that “my daughter wouldn't be able to do this” and others indicated “as long as I was supervising, I think my daughter could take this medication safely and not become pregnant.”

In furtherance of patient compliance, the method according to the present invention further may include the step of providing survey materials to the prescribers for distribution to the patients regarding what the patients need to know about the adverse side effects while taking the doses and implementation by the patient of what the patient must do in order to prevent the adverse effect while taking the doses and to receive prescriptions for the doses.

Such as survey materials preferably include questions regarding patient materials and instruction such as but not limited to:

Was the patient reminded about the risk of serious birth defects, miscarriages or death of baby while taking the study medication; and importance of avoiding pregnancy while taking the study medication? Was the patient reminded about the need to use two effective forms of birth control such as hormonal pill, hormonal implant, tubal ligation, vasectomy, IUD; condom, diaphragm, cervical cap, spermicide? Was the patient instructed not to become pregnant until after the patient's last study visit?

Questions regarding study medication status such as: is the patient taking the study medication and if they are currently participating in the study; questions regarding continuing treatment, such as if a urine pregnancy test was performed before the patient received a new bottle of study medication.

Survey material further should include questions such as birth control methods used, such as what type(s) of birth control the patient is currently using such as tubal ligation, vasectomy, Depo-Provera® Injection, oral contraceptive, IUD, rhythm method, diaphragm, cervical cap, latex condoms, Norplant®, spermicide, abstinence, none or other; if the patient's doctor indicated that for medical reasons the patient must use barrier methods only; if the patient is having sexual intercourse and if they are that they are using the required birth control methods every time the patient had sexual intercourse since the screening visit; if the patient missed their period or if their period is late; if the patient is pregnant; if the patient is pregnant, if they had a pregnancy test and if the pregnancy test is positive; questions regarding study medication and pregnancy, such as the patient should not become pregnant while taking study medication; that the patient should not become pregnant during the study; that the patient should not become pregnant until at least one menstrual cycle passes following the end of treatment; that the patient should have sexual intercourse while using two effective forms of birth control and that emergency contraception is available.

The method in accordance with the present invention further preferably includes the step of receiving completed surveys from the patients and advising the prescribers as to the continuance and/or discontinuance of prescribing the doses for the patients.

Further, enablement of drug delivery may optionally include the step of distributing educational materials to pharmacies including pharmacy personnel, such as, pharmacists, with the educational materials, with the educational materials including information as to what the patients need to know and what the patients must do in both avoid adverse side effects while taking the doses and receive the prescription dose from the pharmacists, such educational materials are being hereinabove described.

In addition, the present method may include the step for providing guidelines to the pharmacists for counseling the patients as hereinabove noted. Preferably, the method includes the step of requiring acknowledgment receipt of the educational materials and guidelines from the pharmacists and further acknowledgement of receipt of educational materials by the patient from the pharmacists.

In order to assess the perceived knowledge of the patient through the distributed educational materials and counseling the method in accordance with the present invention may further comprise the step orchestrating focus groups for potential patients with regard to what the potential patient needs to know and what the patient must do in order to avoid the adverse side effects.

Educational materials may be distributed, counseling provided to the potential patients and thereafter personal surveys or written surveys may be conducted in order to determine whether the educational materials and the guidelines are comprehensible and are correctly perceived.

The present invention further encompasses a method for evaluating effectiveness of educational materials used in a method for delivery of an active agent to a patient. Such method may comprise the steps of distributing educational materials to personnel who are qualified in carrying out the method requirements, said educational materials including information as to what patients need to know and what the patients must do in order to both avoid adverse side effects while taking the doses and to receive a prescription for the doses and providing guidelines to the counselor for counseling individuals with regard to what the patients need to know and what the patients must do in order to both avoid the adverse side effect while taking the dose and to receive prescriptions for the doses.

Subsequent to counseling, focus groups, as hereinabove described, are orchestrated for the counseled individuals with regard to what the patients need to know and what the patients must do in order to avoid the adverse side effect and what to do if the adverse effect is experienced, in order to assess the perceived knowledge of the counseled individual. In addition, as hereinabove noted the focus groups may be utilized to determine effectiveness in the order of presentation of materials, i.e. brochures, videos, etc., to the counseled individual.

Finally, the present invention includes a method for conducting a clinical study for enabling delivery of an active agent. Said method may comprise the steps of preparing prescription doses of one or more active agents and placebo and providing unidentified prescription doses and placebos to prescribers who are qualified to dispose the unidentified prescription doses and placebos to patients.

In addition, educational materials are distributed to the prescribers, said educational materials including information as to what the patient needs to know and what the patents must do in order to both avoid an undesirable side effect and to receive one of the unidentified prescription doses and placebos.

Guidelines are provided to the prescribers for counseling the patients with regard to what the patients need to know and what the patients must do in order to both avoid the undesirable side effect and to receive on of the unidentified prescription doses and placebo and acknowledgment of receipt of the educational material and guidelines may be required.

Survey materials for distribution to the patients regarding what the patients need to know about avoiding the undesirable side effect while taking on the unidentified prescribed doses and the placebos and implementation by the patients of what the patient must do in order to both avoid the undesirable side effect and receive one of the unidentified prescription doses and placebos.

Completed surveys are received from the patients and the prescribers are advised as to providing one of the unidentified prescription doses and placebos to the patients. Reports are received from the prescribers as to the effectiveness of administered prescription doses and placebos and the received surveys are statistically analyzed.

Although there has been hereinabove described a specific method in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclose herein. Accordingly, any and all modifications, variations or equivalent arrangements which may occur to those skilled in the art, should be considered to be within the scope of the present invention as defined in the appended claims.

[image]

[image]

[image]

[image]

[image]

[image]

[image]

[image]

[image]

[image]

[image]

[image]

[image]

[image]

[image]

[image]

1. A method for delivering an active agent to a patient in a manner avoiding the occurrence of an adverse side effect known or suspected of being caused by the active agent, said method comprising the steps of:
distributing educational materials to medical office personnel including prescribers who are qualified to prescribe the doses for patients, said educational materials including information as to what the patients need to know and what the patients must do in order to both avoid adverse side effects while taking the doses and to receive a prescription for the doses;
providing guidelines for counseling the patients with regard to what the patients need to know and what the patients must do in order to both avoid the adverse side effect while taking the dose and to receive prescriptions for the doses;
orchestrating focus groups for potential patients with regard to what the patients need to know and what the patients must do in order to both avoid the adverse side effect and to receive the prescription; and
assessing the perceived knowledge of the potential patient before prescribing the doses for the patients.

2. The method according to claim 1 wherein the step of orchestrating focus groups includes determining from patient feedback a preferred order of presentation of the distributed materials.

3. The method according to claim 1 wherein the step of distributing education materials including distributing materials as to what the patients needs to know and what the patient needs to do if experiencing an adverse side effect and the focus group are further orchestrated with regard to what the patient needs to know and what the patient needs to do if experiencing an adverse side effect.

4. The method according to claim 2 wherein the distributed materials include brochures and video materials.

5. The method according to claim 1 further comprising the step of requiring proof of focus group attendance by the patient in order for the patient to receive doses.

6. The method according to claim 1 wherein the adverse side effect is at least one of the group consisting of and pregnancy and cheilitis, dry skin, skin fragility pruritus, epistaxis, dry nose and dry mouth and conjunctivitis.

7. The method according to claim 1 wherein the active agent comprises Tazarotene and the side effect comprises pregnancy.

8. The method according to claim 1 wherein the guidelines are provided to the prescribers and the method further comprises the step of requiring acknowledgment of receipt of the educational materials and guidelines from the prescribers.

9. The method according to claim 7 further comprising the step of requiring acknowledgment by the patients receipt of the education materials from the patient.

10. The method according to claim 8 further comprising the step of providing survey materials to the prescribers for distribution to the patients regarding what the patients need to know about the adverse side effect while taking the doses and implementation by the patient of what the patient must do in order to avoid the adverse effect while taking the doses and to receive prescription for the doses.

11. The method according to claim 10 further comprising the step of receiving completed surveys from the patient and advising the prescribers as to continuance and discontinuance of prescribing doses for the patients.

12. The method according to claim 11 wherein the active agent is Tazarotene and the adverse effect is pregnancy.

13. The method according to claim 1 or 12 further comprising the step of distribution prescribable doses to pharmacies.

14. The method according to claim 13 further comprising the step of distributing educational material to the pharmacy personnel including pharmacists, said educational materials including information as to what the patients need to know and what the patients must do in order to both avoid the adverse side effect while taking the doses and to receive the prescription dose from the pharmacist.

15. The method according to claim 14 further comprising the step of providing guidelines to the pharmacist for counseling the patients with regard to what the patient needs to know and what the patient must do in order to both avoid the adverse side effect while taking the doses and to receive doses from the pharmacist.

16. The method according to claim 15 further comprising the step of requiring acknowledgment of receipt of the education materials and guidelines from the pharmacist.

17. The method according to claim 16 further comprising the step of requiring acknowledgment of receipt of the education materials by the patient from the pharmacist.

18. The method according to claim 1 or 12 wherein said education materials are age and sex appropriate.

19. The method according to claim 18 wherein said education materials are selected from the group consisting of video tape, audio tape, CDs, brochures and line drawings.

20. A method for evaluating effectiveness of educational materials used in a method for delivery of an active agent to a patient, said method comprising the steps of:
distributing educational materials to counselors who are qualified to counsel patients, said educational materials including information as to what patients need to know and what the patients must do in order to both avoid adverse side effects while taking the doses and to receive a prescription for the doses;
providing guidelines to the counselor for counseling individuals with regard to what the patients need to know and what the patients must do in order to both avoid the adverse side effect while taking the dose and to receive prescriptions for the doses;
subsequent to counseling, orchestrating focus groups for the counseled individuals with regard to what the patients need to know and what the patients must do in order to both avoid the adverse side effect and to receive the prescription; and
assessing the perceived knowledge of the counseled individual.

21. The method according to claim 20 wherein the step of orchestrating focus groups includes determining from patient feedback a preferred order of presentation of the distributed materials.

22. The method according to claim 20 wherein the step of distributing education materials including distributing materials as to what the patient needs to know and what the patient needs to do if experiencing an adverse side effect and the focus group are further orchestrated with regard to what the patient needs to know and what the patient needs to do if experiencing an adverse side effect.

23. The method according to claim 21 wherein the distributed materials include brochures and video materials.

24. A method for conducting a clinical study for enabling delivery of an active agent, said method comprising the steps of:
preparing prescription doses of an active agent and placebo;
providing unidentified prescription doses and placebos to prescribers who are qualified to dispose the unidentified prescription doses and placebos to patients;
distributing educational materials to the prescribers, said educational materials including information as to what the patient needs to know and what the patents must do in order to both avoid an undesirable side effect and to receive one of the unidentified prescription doses and placebos;
providing guidelines to the prescribers for counseling the patients with regard to what the patients need to know and what the patients must do in order to both avoid the undesirable side effect and to receive on of the unidentified prescription doses and placebo;
requiring acknowledgment of receipt of the educational material and guidelines;
providing survey material for distribution to the patients regarding what the patients need to know about avoiding the undesirable side effect while taking on the unidentified prescribed doses and the placebos and implementation by the patients of what the patients must do in order to both avoid the undesirable side effect and receive one of the unidentified prescription doses and placebos;
receiving completed surveys from the patients;
advising the prescribes as to providing one of the unidentified prescription doses and placebos to the patients;
receiving reports from the prescribers as to the effectiveness of administered prescription doses and placebos; and
statistically analyzing received surveys.

25. The method according to claim 24 wherein the active agent comprises Tazarotene and the side effect comprises pregnancy.

26. The method according to claim 24 further comprising the step of requiring acknowledgment from the patients of receipt of the education materials.

27. The method according to claim 26 further comprising the step of providing survey materials to the prescribers for distribution to the patients regarding what the patients need to know about the adverse side effect while taking the doses and implementation by the patients of what the patients must do in order to avoid the adverse effect while taking the doses and to receive prescription for the doses.

28. The method according to claim 27 further comprising the step of receiving completed surveys from the patient and advising the prescribers as to continuance and discontinuance of prescribing doses for the patients.

29. The method according to claim 28 wherein the active agent is Tazarotene and the adverse effect is pregnancy.

30. The method according to claim 24 or 29 wherein said education materials are age and sex appropriate.

31. The method according to claim 30 wherein said education materials are selected from the group consisting of video tape, audio tape, CDs, brochures and line drawings.

32. The method according to claim 24 further comprising the step of orchestrating focus groups for patients with regard to what the patient need to know and what the patient must do in order to both avoid the adverse side effect and to receive a prescription for the doses.

33. The method according to claim 32 further comprising the step of requiring proof of focus group attendance by the patient in order for the patient to receive doses.

34. The method according to claim 32 wherein the step of orchestrating focus groups includes determining from patient feedback a preferred order of presentation of the distributed materials.

35. The method according to claim 34 wherein the distributed materials include brochures and video materials.
